(19) United States
(12) Patent Application Publication
(10) Pub. No.: US 2025/0304879 A1
(43) Pub. Date: Oct. 2, 2025

(54) SLURRY SEPARATION SYSTEM

(71) Applicant: David MARTIN, Madison, SD (US)

(72) Inventor: David MARTIN, Madison, SD (US)

(21) Appl. No.: 19/095,935

(22) Filed: Mar. 31, 2025

Related U.S. Application Data
(60) Provisional application No. 63/572,466, filed on Apr. 1, 2024.

(51) Int. Cl. C11B 7/00; C11B 11/00; C11B 13/00; C11B 15/00

(52) U.S. Cl. CPC C11B 7/0075; C11B 11/00; C11B 13/00; C11B 15/00

(57) ABSTRACT

A system and method effect the separation of wax and oil from a sorghum slurry. The sorghum slurry is mixed with supercritical CO₂ to create a first output, and the first output is mixed with liquid CO₂ causing a sudden drop in temperature such that solid wax particles drop from the first output to create a second output of CO₂ and oil. The second output is heated while reducing pressure such that the CO₂ is put into a gas phase and the oil separates from the CO₂.

### CROSS-REFERENCES TO RELATED APPLICATIONS

This application claims the benefit of U.S. Provisional Patent Application No. 63/572,466, filed Apr. 1, 2024, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to processing byproducts of bioethanol production and, more particularly, to a slurry separation system for extracting wax and oil.

Byproducts of bioethanol production operations include a slurry composed of wax and oil. All slurries are waxy including those produced from corn and sorghum. Conventional separation methods have not been successful at economically separating the wax and oil. For example, the use of filter plates with filter papers and/or different types of media packed into the filter plates (e.g., activated carbon) have problems with clogging, which requires frequent replacement resulting in substantial down time and added employee hours. There are also difficulties in getting the wax from the filter papers.

Centrifuges have also been used without success as the resulting products are not fully separated.

It has been discovered that sorghum is particularly waxy and can be a productive target for slurry separation.

### SUMMARY

The system of the described embodiments separates the sorghum wax from the sorghum oil economically. The wax can compete in the carnauba wax market. The carnauba wax market is derived outside of the U.S. and is industrially important to the U.S. Eleven million pounds of this wax are imported into the U.S. from Brazil every year. The sorghum wax would be a domestic source of a hard, high-melting-point wax that could compete internationally with carnauba. The oil will be ready for conversion to biodiesel or to be used as industrial lubricant. Currently there are 207 million pounds of sorghum slurry produced and wasted annually.

The system of the described embodiments utilizes CO₂ in various phases along with heat and various chambers to effectively and efficiently separate wax and oil from a sorghum slurry.

In an exemplary embodiment, a system for separating wax and oil from a sorghum slurry includes a slurry supply tank heated to a temperature equal to or above a melting temperature of sorghum wax and a CO₂ supply tank storing CO₂ in liquid phase. A slurry line from the slurry supply tank includes a first pump and a first heat exchanger, and a CO₂ line from the CO₂ supply tank includes a second pump and a second heat exchanger. The second pump and the second heat exchanger are configured to put the CO₂ into a supercritical state. A dissolving chamber receives output from the slurry supply tank via the slurry line mixed with the supercritical CO₂ via the CO₂ line. A precipitation chamber receives output from the dissolving chamber mixed with CO₂ in liquid phase from the CO₂ supply tank. The CO₂ in liquid phase solidifies the wax and separates the wax from the slurry such that the wax precipitates by gravity to the bottom of the precipitation chamber. An output line from the precipitation chamber through which a mixture of CO₂ and oil flow includes a third heat exchanger that is configured to heat the mixture and a flow regulator that is configured to reduce pressure in the output line. A separation chamber receives CO₂ and oil from the output line, where the CO₂ is in a gas phase, and where the oil separates from the CO₂.

The CO₂ line from the CO₂ supply tank may include a sub-line with a fourth heat exchanger that cools the CO₂ to a temperature below 0 degrees C. The sub-line may mix with the output line ahead of the precipitation chamber. The system may include a third pump on the sub-line. A ratio of the CO₂ to the output from the dissolving chamber may be at least 7:1.

The system may further include a return line that carries CO₂ from the separation chamber. The return line may include a fifth heat exchanger that cools the CO₂ from gas phase to liquid phase.

A ratio of the supercritical CO₂ from the CO₂ supply line to the slurry in the slurry line may be at least 6.14:1.

In another exemplary embodiment, a method of separating wax and oil from a sorghum slurry includes the steps of (a) inputting a mix of the sorghum slurry and supercritical CO₂ into a dissolving chamber; (b) separating the wax from the sorghum slurry in a precipitation chamber by mixing output from the dissolving chamber with liquid CO₂; and (c) heating output from the precipitation chamber such that the CO₂ is in a gas phase, thereby separating the oil from the CO2 in a separation chamber.

The method may additionally include storing the sorghum slurry in a slurry supply tank at a temperature above a melting point of the wax and at a predetermined pressure, and storing liquid CO₂ in a CO₂ supply tank. In this context, step (a) may be practiced by outputting the sorghum slurry from the slurry supply tank and by outputting the CO₂ from the CO₂ supply tank. The predetermined pressure may be 700-1400 psi. The method may further include, prior to step (a), heating and pressurizing the liquid CO₂ into the supercritical CO₂.

The method may also include, prior to step (b), outputting liquid CO₂ from the CO₂ supply tank to a heat exchanger to cool the CO₂ to a temperature below 0 degrees C., where the liquid CO₂ in step (b) comprises the cooled CO₂.

Step (b) may further include collecting solid wax particles in the precipitation chamber, and melting the solid wax particles for retrieval via a wax drain.

Step (c) may include heating the output from the precipitation chamber and reducing the pressure such that the CO₂ is in the gas phase. In this context, the method may include draining the oil from the separation chamber.

The method may still further include, after step (c), cooling the CO₂ to be in a liquid phase, and returning the CO₂ to the CO₂ supply tank.

In yet another exemplary embodiment, a method of separating wax and oil from a sorghum slurry includes the steps of mixing the sorghum slurry with supercritical CO₂ to create a first output; mixing the first output with liquid CO₂ causing a sudden drop in temperature such that solid wax particles drop from the first output to create a second output of CO₂ and oil; and heating the second output while reducing pressure such that the CO₂ is put into a gas phase and the oil separates from the CO₂.

### BRIEF DESCRIPTION OF THE DRAWINGS

These and other aspects and advantages will be described in detail with reference to the accompanying drawing, in which:

FIG. 1 is a schematic diagram of the slurry separation system according to the described embodiments.

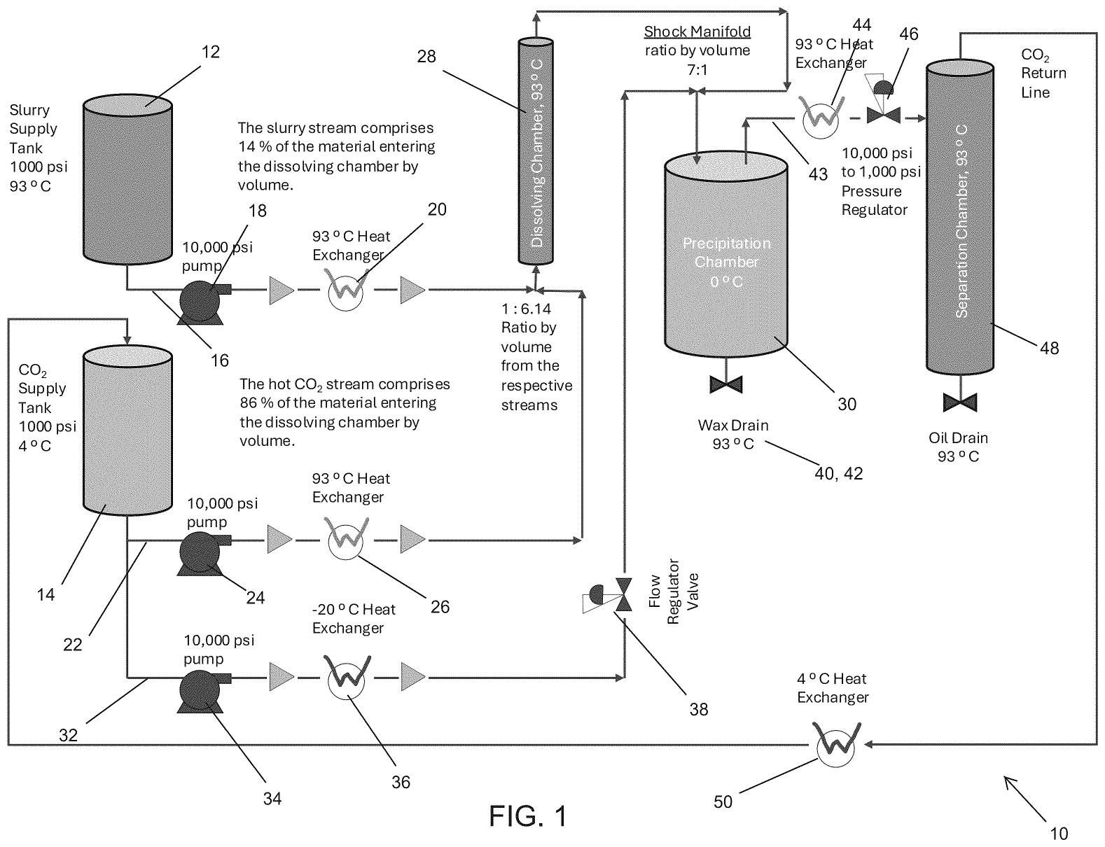

### DETAILED DESCRIPTION

With reference to the drawing, the system 10 includes a slurry supply tank 12 heated to a temperature equal to or above a melting temperature of sorghum wax. With the melting point of the sorghum wax at 83 degrees C., the slurry supply tank may be heated to a temperature around 93 degrees C. up to 215 degrees C. Above 215 degrees C., the wax may burn or become discolored.

The slurry supply tank 12 may be maintained at pressures between 700-1400 psi. The pressure enables the tank to feed a downstream pump. If the pressure is too low, the downstream pump will be inefficient. Pressures above 1400 psi pose safety risks and add substantial costs.

A CO₂ supply tank 14 stores CO₂ in liquid phase. In some embodiments, the CO₂ may be stored at 4 degrees C. at a pressure around 1000 psi. The CO₂ at 4 degrees C. keeps the CO₂ dense enough in liquid phase to make it efficient while maintaining economic feasibility. Temperatures below −11 degrees C. could cause the oil to solidify, which is undesirable. Temperatures above 12 degrees C. will significantly slow the process.

The CO₂ supply tank 14 may include top-mounted valves enabling removal of nitrogen or oxygen should they get into the system.

A slurry line 16 from the slurry supply tank 12 includes a first pump 18 (i.e., the downstream pump discussed above) and a first heat exchanger 20. The first pump 18 raises the pressure in the line 16, and the heat exchanger 20 raises the temperature in the line 16. The pressure and temperature are set to dissolve all wax and oil components of the sorghum slurry.

A CO₂ line 22 from the CO₂ supply tank 14 includes a second pump 24 and a second heat exchanger 26. The CO₂ may be passed through one or more check valves. The second pump 24 and the second heat exchanger 26 function to elevate the CO₂ into a supercritical state. The CO₂ solvent is in a continuous loop being pumped from a storage pressure/temperature in liquid phase in the CO₂ supply tank 14 to a dissolving temperature/pressure in a supercritical state. In an exemplary embodiment, the wax and oil components in the slurry are dissolved in supercritical CO₂ at 10,000 psi and 93 degrees C. Higher pressures increase safety concerns and would affect the price of the machinery. Lower pressures (e.g., below 6,000 psi) would not push enough throughput for economical operation.

A dissolving chamber 28 receives output from the slurry supply tank 12 via the slurry line 16 mixed with the supercritical CO₂ via the CO₂ line 22. That is, slurry (composed of oil and wax) is heated to a temperature above the wax melting point and is passed through a pump pressurizing the slurry, e.g., to 10K psi. The slurry passes through a check valve and is injected into the dissolving chamber 28 at a rate that ensures that the slurry is continuously and completely dissolved. In some embodiments, the slurry is injected into the dissolving chamber 28 at a rate of at most 14% of the total CO₂ slurry stream by volume, with the other 86% of the stream being comprised of CO₂. This is thus at least a 6.14:1 ratio between the CO₂ and slurry volumes, respectively. If the ratio is increased resulting in an increased amount of slurry, it would be difficult if not impossible to dissolve at this pressure. An increased ratio could be successful with higher pressure, enabling the system to throughput more slurry.

The CO₂ stream and slurry stream may also merge outside the dissolving chamber 28 and then enter the dissolving chamber 28 together as shown in the drawing. The dissolving chamber 28 endeavors to accomplish two things. First, the dissolving chamber 28 allows time for the slurry to be dissolved completely into solution. Second, if a slurry component does not dissolve, it gives a location for this insoluble material to sit and not be carried over into the downstream process components.

The colliding or mixing point outside the dissolving chamber 28 allows for the insertion of perforated, sintered, porous, or other types of screens or mixing devices at this location and downstream of it to assist with dissolution. For reference, this is different from current state-of-the-art designs that use a batch method. This method also allows the system to scale up to any rate of slurry production, preventing the described system from being a bottleneck in production.

In some embodiments, the dissolving chamber 28 may include a heater (not shown) in case of component shut down or to maintain elevated temperatures.

A precipitation chamber 30 receives output from the dissolving chamber 28 mixed with CO₂ in liquid phase from the CO₂ supply tank 14. A sub-line 32 from the CO₂ supply tank 14 includes a pump 34 that increases the pressure in the sub-line 32 and a heat exchanger 36 that cools the CO₂ to a temperature below 0 degrees C. In some embodiments, the heat exchanger cools the CO₂ to −20degrees C. The sub-line 32 may also include a flow regulator valve 38 to control CO₂ flow. The CO₂ in the sub-line 32 mixes with material in the output line from the dissolving chamber 28 ahead of the precipitation chamber 30, where the CO₂ in liquid phase suddenly cools the mixture and solidifies the wax.

In some embodiments, the injection of one or more CO₂ co-streams are at a temperature below 0 degrees C. With one CO₂ co-stream, the CO₂ will be at least seven times the volume of the supercritical slurry stream and at −20 degrees C. or lower. That is, a ratio of CO₂ to the slurry stream at this point is at least 7:1. The suddenly combined streams change the state of the initial CO₂ slurry from supercritical to liquid. This phase change drops the wax components out of solution leaving the oil dissolved.

The wax is collected via gravity separation. Filtration may be added to the inside of the precipitation chamber 30 at its exit port as needed to ensure wax does not carry over into the separation chamber 48. A wax drain 40 may include a heater 42 or the system may be configured to pump steam into the precipitation chamber 30 to melt the solidified wax for retrieval from the bottom of the precipitation chamber 30. Multiple precipitation chambers may be set in a manifold to allow for the depressurization, heating, and draining of each as they fill with wax. In this way, the process can continue uninterrupted.

An output line 43 from the precipitation chamber 30 carries a mixture of CO₂ and oil. The output line 43 includes a heat exchanger 44 that is configured to heat the mixture and a pressure regulator 46 that is configured to reduce pressure in the output line 43.

The separation chamber 48 receives CO2 and oil from the output line 43, where the CO₂ is heated by the heat exchanger 44 to be in a gas phase, and where the oil then separates from the CO₂. That is, when the pressure regulator 46 drops the pressure (e.g., to 1000 psi), the CO₂ is no longer supercritical. The oil is in liquid form and heated so does not solidify and is not sticky. As such, the oil flows to the bottom of the separation chamber. The CO₂ is in gas phase and flows out the top naturally, and is cooled back into liquid phase at a downstream heat exchanger. Multiple separation chambers 48 may be lined up in series to accommodate a series of smaller pressure drops on the stream's progress toward a lower pressure (e.g., 1000 psi). This allows for not only the specific separation of chemical species by pressure change, but the inclusion of filter media to remove components such as color bodies.

In some embodiments, the oil-CO₂ solution is heated once again to 93 degrees C. to compensate for heat loss due to expansion, preventing clogs in the next step. Solution pressure is dropped through the pressure regulator 46, e.g., to 1000 psi, precipitating the oil without wax contaminants.

The CO₂ is cooled by a downstream heat exchanger 50, e.g., to 4 degrees C., and the CO₂ is returned to the CO₂ supply tank 14 ready to be recirculated.

The system may also include various temperature sensors, pressure relief valves, feedback loops, and other safety components to ensure safe and efficient operation.

The system of the described embodiments utilizes CO₂ in various phases along with temperature and pressure variations and various chambers to effectively and efficiently separate wax and oil from a sorghum slurry.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A system for separating wax and oil from a sorghum slurry, the system comprising:
a slurry supply tank heated to a temperature equal to or above a melting temperature of sorghum wax;
a CO₂ supply tank storing CO₂ in liquid phase;
a slurry line from the slurry supply tank including a first pump and a first heat exchanger;
a CO₂ line from the CO₂ supply tank including a second pump and a second heat exchanger, the second pump and the second heat exchanger are configured to put the CO₂ into a supercritical state;
a dissolving chamber receiving output from the slurry supply tank via the slurry line mixed with the supercritical CO₂ via the CO₂ line;
a precipitation chamber receiving output from the dissolving chamber mixed with CO₂ in liquid phase from the CO₂ supply tank, wherein the CO₂ in liquid phase solidifies the wax and separates the wax from the slurry such that the wax precipitates by gravity to a bottom of the precipitation chamber;
an output line from the precipitation chamber through which a mixture of CO₂ and oil flow, the output line including a third heat exchanger that is configured to heat the mixture and a flow regulator that is configured to reduce pressure in the output line; and
a separation chamber receiving CO₂ and oil from the output line, wherein the CO₂ is in a gas phase, and wherein the oil separates from the CO₂.

2. A system according to claim 1, wherein the CO₂ line from the CO₂ supply tank comprises a sub-line, the system further comprising a fourth heat exchanger on the sub-line that cools the CO₂ to a temperature below 0 degrees C., the sub-line mixing with the output line ahead of the precipitation chamber.

3. A system according to claim 2, further comprising a third pump on the sub-line.

4. A system according to claim 2, wherein a ratio of the CO₂ to the output from the dissolving chamber is at least 7:1.

5. A system according to claim 1, further comprising a return line that carries CO₂ from the separation chamber, the return line including a fifth heat exchanger that cools the CO₂ from gas phase to liquid phase.

6. A system according to claim 1, wherein a ratio of the supercritical CO₂ from the CO₂ line to the slurry in the slurry line is at least 6.14:1.

7. A method of separating wax and oil from a sorghum slurry, the method comprising:
(a) inputting a mix of the sorghum slurry and supercritical CO₂ into a dissolving chamber;
(b) separating the wax from the sorghum slurry in a precipitation chamber by mixing output from the dissolving chamber with liquid CO₂; and
(c) heating output from the precipitation chamber such that the CO₂ is in a gas phase, thereby separating the oil from the CO₂ in a separation chamber.

8. A method according to claim 7, further comprising storing the sorghum slurry in a slurry supply tank at a temperature above a melting point of the wax and at a predetermined pressure, and storing liquid CO₂ in a CO₂ supply tank, wherein step (a) is practiced by outputting the sorghum slurry from the slurry supply tank and by outputting the CO₂ from the CO₂ supply tank.

9. A method according to claim 8, wherein the predetermined pressure is 700-1400 psi.

10. A method according to claim 8, further comprising, prior to step (a), heating and pressurizing the liquid CO₂ into the supercritical CO₂.

11. A method according to claim 7, further comprising, prior to step (b), outputting liquid CO₂ from a CO₂ supply tank to a heat exchanger to cool the CO₂ to a temperature below 0degrees C., wherein the liquid CO₂ in step (b) comprises the cooled CO₂.

12. A method according to claim 7, wherein step (b) further comprising collecting solid wax particles in the precipitation chamber, and melting the solid wax particles for retrieval via a wax drain.

13. A method according to claim 7, wherein step (c) comprises heating the output from the precipitation chamber and reducing a pressure such that the CO2 is in the gas phase.

14. A method according to claim 13, further comprising draining the oil from the separation chamber.

15. A method according to claim 7, further comprising, after step (c), cooling the CO₂ to be in a liquid phase, and returning the CO₂ to a CO₂ supply tank.

16. A method according to claim 7, wherein step (a) is practiced such that a ratio of the supercritical CO₂ to the sorghum slurry is at least 6.14:1.

17. A method according to claim 7, wherein step (b) is practiced such that a ratio of the liquid CO₂ to the output from the dissolving chamber is at least 7:1.

18. A method of separating wax and oil from a sorghum slurry, the method comprising:
mixing the sorghum slurry with supercritical CO₂ to create a first output;
mixing the first output with liquid CO₂ causing a sudden drop in temperature such that solid wax particles drop from the first output to create a second output of CO₂ and oil; and
heating the second output while reducing pressure such that the CO₂ is put into a gas phase and the oil separates from the CO₂.
